(19) United States
(12) Patent Application Publication
(10) Pub. No.: US 2020/0400162 A1
(43) Pub. Date: Dec. 24, 2020

(54) CONTROLLER MOUNTING STRUCTURE OF CEILING FAN AND CEILING FAN LAMP USING DC BRUSHLESS MOTOR

(71) Applicant: Guangdong Zhaoli Motor Co., Ltd, Zhongshan (CN)

(72) Inventors: Xuhui He, Zhongshan (CN); Changzheng Xie, Zhongshan (CN); Guangliang Tang, Zhongshan (CN)

(21) Appl. No.: 16/709,979

(22) Filed: Dec. 11, 2019

(30) Foreign Application Priority Data
Jun. 19, 2019 (CN) 201920928986.7
Jun. 19, 2019 (CN) 201920937215.4

(51) Int. Cl. F04D 29/64; H02P 7/03; H02K 5/22; H02K 7/116; H02K 7/14; H02K 9/22; H02K 11/00; H02K 11/28; H02K 11/30; H02K 11/40; F21V 33/00; F21V 23/04; F04D 29/58; F04D 25/06; F28F 21/02

(52) U.S. Cl. CPC F04D 29/646; H02K 2211/03; H02K 5/225; H02K 7/116; H02K 7/14; H02K 9/22; H02K 11/0094; H02K 11/28; H02K 11/30; H02K 11/40; F21V 33/0096; F21V 23/04; F04D 29/5853; F04D 25/06; F28F 21/02; H02P 7/05

(57) ABSTRACT

The present application discloses a controller mounting structure of a ceiling fan and a ceiling fan lamp using a DC brushless motor, including a control box disposed below the DC brushless motor of the ceiling fan, and a controller body disposed inside the control box and electrically connected to the DC brushless motor. The control box includes a metal upper case and a metal lower cover coupled with the metal upper case. The metal upper case is provided with a first switch for controlling clockwise and anti-clockwise rotation function of the fan, and a second switch for controlling rotating speed, gear shifting and stopping functions of the fan. The first switch and the second switch are independently connected to the controller body through electric wires respectively. The controller mounting structure can improve the cost-performance ratio of the DC brushless motor controller, and facilitate maintenance of the product.

### CROSS REFERENCE TO RELATED APPLICATIONS

The present application claims priority to and the benefits of Chinese Utility Model Application Nos. 201920928986.7 and 201920937215.4 both filed on Jun. 19, 2019, the contents which are hereby incorporated by reference.

### TECHNICAL FIELD

The present disclosure relates to the technical field of ceiling fans, in particular to a controller mounting structure of a ceiling fan and a ceiling fan lamp using a DC brushless motor.

### BACKGROUND

With the development of industry, ceiling fans in all countries of the world previously driven by AC capacitor motors are gradually switched to DC brushless motors. After being driven by a DC brushless motor, the controller of the ceiling fan is usually placed above the ceiling fan motor, or placed on an upper bell or fixed on a ceiling rod. Signals are transmitted through a remote control handle. After receiving the signals, the controller controls various functions of the ceiling fan, such as changing the rotating speed and gear, switching the directions of rotation, etc. However, when using a remote control handle to send signals, the signals sometimes are unstable. It is inconvenient to operate and the price is high. It also does not facilitate maintenance of the products.

### SUMMARY

In order to overcome the above existing problems, the present disclosure provides a controller mounting structure of a ceiling fan and a ceiling fan lamp using a DC brushless motor.

The technical solution of the present disclosure is a controller mounting structure of a ceiling fan using a DC brushless motor, including a control box disposed below the DC brushless motor of the ceiling fan; a controller body disposed inside the control box and electrically connected to the DC brushless motor; the control box including a metal upper case and a metal lower cover coupled with the metal upper case, wherein the metal upper case is provided with a first switch for controlling clockwise and anti-clockwise rotation function of the fan, and a second switch for controlling rotating speed, gear shifting and stopping functions of the fan, the first switch and the second switch are independently connected to the controller body through electric wires respectively, the controller body including a case body, a heat sink, and a circuit board located in the case body, wherein the case body is formed by an upper plastic outer shell and a lower plastic outer shell, a heat sink fixing trough is provided on top of the upper plastic outer shell, the heat sink is connected to a discrete component on the circuit board and its upper surface is in contact with the metal upper case, the circuit board is pre-set with several wiring sockets, and the lower plastic outer shell is provided with several socket slot holes that correspond to the wiring sockets, and several heat-dissipating holes.

An upper surface of the metal upper case is provided with an upwardly protruding raised platform, the upper surface of the metal upper case is provided with several screw holes for fixing the controller body, the raised platform is provided with a fixing hole for fixing a ground wire, and a through hole for facilitating electrical connection between the DC brushless motor and the controller body, a side surface of the metal upper case is provided with two independent and separate hole locations for fixing the first switch and the second switch respectively, and positioning holes corresponding to the screw holes are provided around the upper plastic outer shell.

A heat-dissipating hole is provided on a side surface of the lower plastic outer shell.

The first switch is a push-setting switch or a rope-pulling switch, and the second switch is a push-setting switch or a rope-pulling switch. The first switch and the second switch are both rope-pulling switches, and pulling ropes of the first switch and the second switch are of different colours.

The metal upper case and the metal lower cover are connected by snap-fitting or fixedly connected by screws.

A controller mounting structure of a ceiling fan lamp using a DC brushless motor, includes a control box disposed below a fan of the ceiling fan lamp using the DC brushless motor; a controller body is provided in the control box, the controller body being electrically connected with the DC brushless motor of the ceiling fan lamp using the DC brushless motor and a lamp of the ceiling fan lamp using the DC brushless motor respectively, the control box including a metal upper case and a metal lower cover coupled with the metal upper case, wherein the metal upper case is provided with a fan control switch, the fan control switch is connected with the controller body through an electric wire, and a bottom of the metal lower cover is connected to a lampshade of the lamp of the ceiling fan lamp using the DC brushless motor.

The fan control switch includes a first switch for controlling clockwise and anti-clockwise rotation function of the fan, and a second switch for controlling starting, rotating speed, gear shifting and stopping of the fan, the first switch and the second switch being independently connected to the controller body through electric wires respectively.

The first switch is a push-setting switch or a rope-pulling switch, and the second switch is a rope-pulling switch.

The structure further includes a third switch for controlling the lamp. The third switch is a rope-pulling switch provided on the metal upper case and connected to the controller body through an electric wire, or a remote control switch fixed to a wall body and connected to the controller body through an electric circuit.

The controller body includes a case body, a heat sink, and a circuit board located in the case body, wherein the case body is formed by an upper plastic outer shell and a lower plastic outer shell, a heat sink fixing trough is provided on the upper plastic outer shell, the heat sink is connected to a discrete component on the circuit board, the circuit board is pre-set with several wiring sockets, and the lower plastic outer shell is provided with several socket slot holes that correspond to the wiring sockets.

An upper surface of the heat sink is in contact with the metal upper case of the control box.

The beneficial effects of the present disclosure: the present disclosure is a controller mounting structure of a ceiling fan using a DC brushless motor. The controller body of the ceiling fan for the DC brushless motor is located in a control box below the DC brushless motor. The controller body is electrically connected to the DC brushless motor. The controller body is electrically connected to the first switch and the second switch fixed on the control box through pre-set wiring sockets, and pulling of relevant rope-pulling switches can control the DC brushless motor of the ceiling fan, such as changing the rotating speed and gear, switching the directions of rotation, etc. For a controller mounting structure of a ceiling fan lamp using a DC brushless motor, the controller body of the ceiling fan lamp for the DC brushless motor is located in a control box, i.e. a lower bell. Control switches are fixed on the control box. The controller body is connected with the control switches through electric wires, and the control switches can be manually pulled or pushed. Using this controller mounting structure has the following advantages: 1. improve the reliability of the DC brushless motor controller; 2. improve the cost-performance ratio of the DC brushless motor controller; 3. facilitate maintenance of the products; 4. meet the market's application habit for the ceiling fan products; 5, good heat dissipation and extension of product life.

### BRIEF DESCRIPTION OF THE DRAWINGS

FIG. 1 is a schematic view of the mounting of a ceiling fan of the present disclosure;

FIG. 2 is a schematic exploded view of the ceiling fan of the present disclosure;

FIG. 3 is a schematic structural diagram of a controller body of the ceiling fan of the present disclosure;

FIG. 4 is a schematic view of the mounting of a ceiling fan lamp of the present disclosure;

FIG. 5 is a schematic exploded view of the ceiling fan lamp of the present disclosure;

FIG. 6 is a schematic structural diagram of a controller body of the ceiling fan lamp of the present disclosure; and

FIG. 7 is a top view of an upper plastic outer shell of the ceiling fan lamp of the present disclosure.

In the figures, 1, DC brushless motor; 2, fan; 3, control box; 31, metal upper case; 311, raised platform; 312, screw hole; 313, fixing hole; 314, through hole; 315, hole location; 316, slot hole; 32, metal lower cover; 321, elastic snapping post; 322, heat-dissipating hole; 4, first switch; 5, second switch; 6, controller body; 61, upper plastic outer shell; 62, lower plastic outer shell; 63, heat sink fixing trough; 64, positioning hole; 65, socket slot hole; 66, heat-dissipating hole; 7, wiring socket; 33, lampshade; 43, slot hole; 44; elastic snapping post; 9, third switch; 81, upper plastic outer shell; 82, lower plastic outer shell; 83, heat sink fixing trough; 84, socket slot hole.

### DETAILED DESCRIPTION

The present disclosure is further described below with reference to the drawings and embodiments.

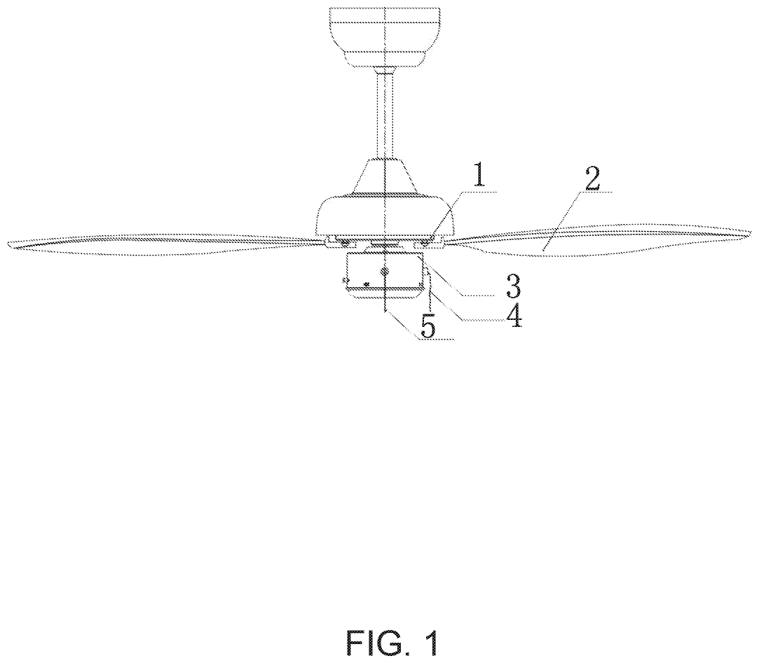

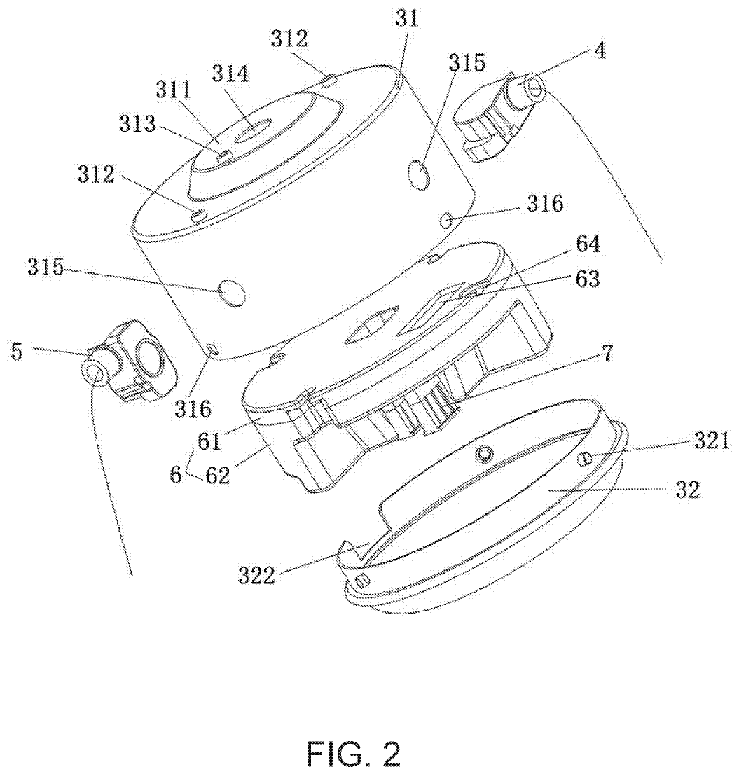

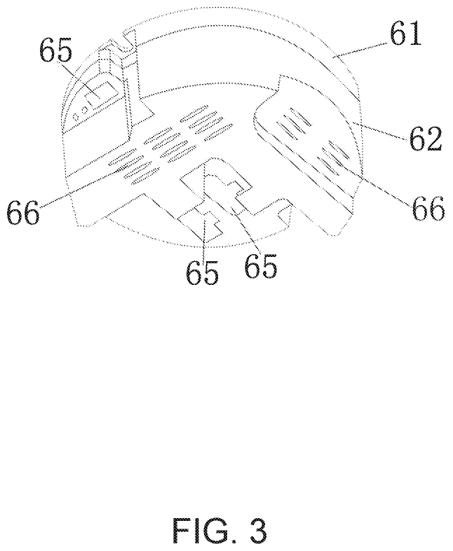

As shown in FIG. 1 to FIG. 3, a controller mounting structure of a ceiling fan 2 using a DC brushless motor 1 may include a control box 3 disposed below the DC brushless motor 1 of the ceiling fan 2 and a controller body 6 disposed inside the control box 3 and electrically connected to the DC brushless motor 1. The control box 3 may include a metal upper case 31 and a metal lower cover 32 coupled with the metal upper case 31. The metal upper case 31 may be provided with a first switch 4 for controlling clockwise and anti-clockwise rotation function of the fan 2, and a second switch 5 for controlling rotating speed, gear shifting and stopping functions of the fan 2. The first switch 4 and the second switch 5 may be independently connected to the controller body 6 through electric wires respectively. The first switch 4 can be a push-setting switch or a rope-pulling switch, and the second switch 5 can be a push-setting switch or a rope-pulling switch. In the present embodiment, the first switch 4 and the second switch 5 are both rope-pulling switches, and the pulling ropes of the first switch 4 and the second switch 5 are of different colours. This can facilitate a user to distinguish which one is for shifting gear and which one is for switching on and off the lamp.

Specifically, the controller body 6 has two electric wires connected to the first switch 4. The switching of clockwise and anti-clockwise directions of rotation of the DC brushless motor 1 can be controlled by pulling the first switch 4 so as to control the directions of rotation of the ceiling fan 2. The controller body 6 has two electric wires connected to the second switch 5. The starting, changing of speed and stopping of the DC brushless motor 1 can be controlled by pulling the second switch 5 so as to control the switching on and off and the adjusting of speed of the ceiling fan 2. The input power line of the ceiling fan 2 may be connected to the controller body 6 through a terminal. The three-phase wiring of the DC brushless motor 1 may be connected to the controller body 6 through the terminal.

The controller body 6 may include a case body, a heat sink, and a circuit board located in the case body. The case body may be formed by an upper plastic outer shell 61 and a lower plastic outer shell 62. A heat sink fixing trough 63 may be provided on top of the upper plastic outer shell 61. The heat sink may be connected to a discrete component on the circuit board and an upper surface of the heat sink may be in contact with the metal upper case 31. The circuit board may be pre-set with several wiring sockets 7, and the lower plastic outer shell 62 may be provided with several socket slot holes 65 that correspond to the wiring sockets 7, and several heat-dissipating holes 66. The heat sink causes the heat of a power module to dissipate through the metal upper case 31. Specifically, the heat sink is an aluminum sheet, or a metal heat sink with a surface coated with a layer of graphene, or a graphene plate. Graphene has a fast heat conduction rate. This can greatly increase the heat dissipation effect and extend the life of the controller body.

An upper surface of the metal upper case 31 may be provided with an upwardly protruding raised platform 311. The upper surface of the metal upper case 31 may be provided with several screw holes 312 for fixing the controller body 6. The raised platform 311 may be provided with a fixing hole 313 for fixing a ground wire, and a through hole 314 for facilitating electrical connection between the DC brushless motor 1 and the controller body 6. A side surface of the metal upper case 31 may be provided with two independent and separate hole locations 315 for fixing the first switch 4 and the second switch 5 respectively. Positioning holes 64 corresponding to the screw holes 312 may be provided around the upper plastic outer shell 61.

A heat-dissipating hole 66 may be provided on a side surface of the lower plastic outer shell 62 in order to further increase the effect of heat dissipation of the controller body.

As a further improvement in the present embodiment, the metal upper case 31 and the metal lower cover 32 may be connected by snap-fitting. Several slot holes 316 may be evenly distributed at a lower portion of the metal upper case 31, and several elastic snapping posts 321 that can be snap-fitted into the slot holes 316 may be evenly distributed at an upper portion of the metal lower cover 32. The metal lower cover 32 and the metal upper case 31 can be easily snap-fitted together by pressing the elastic snapping posts 321. This is convenient for disassembly and maintenance.

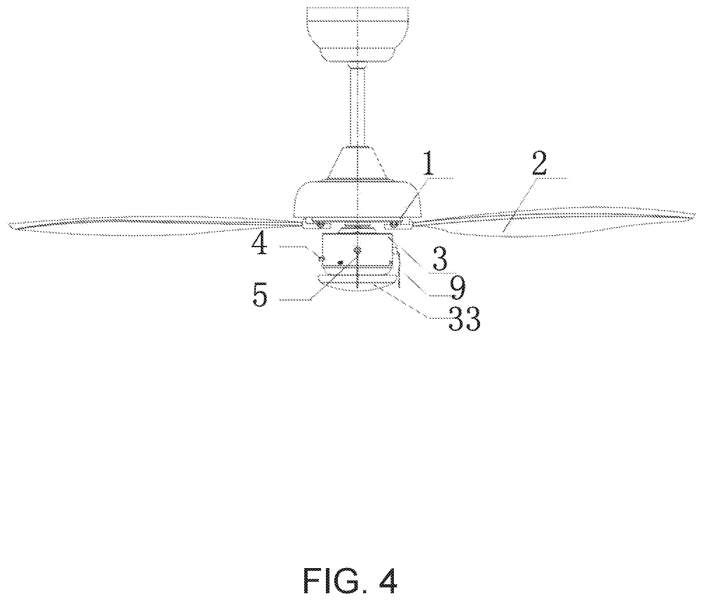

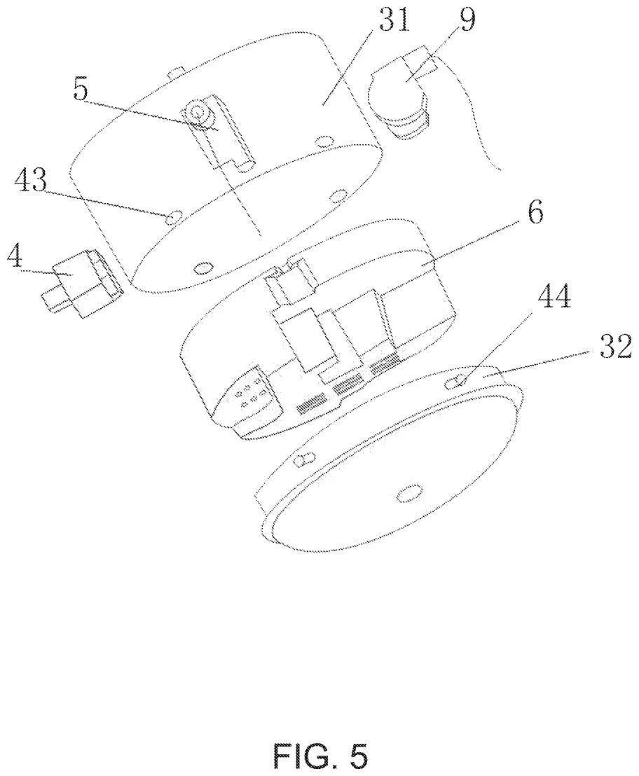

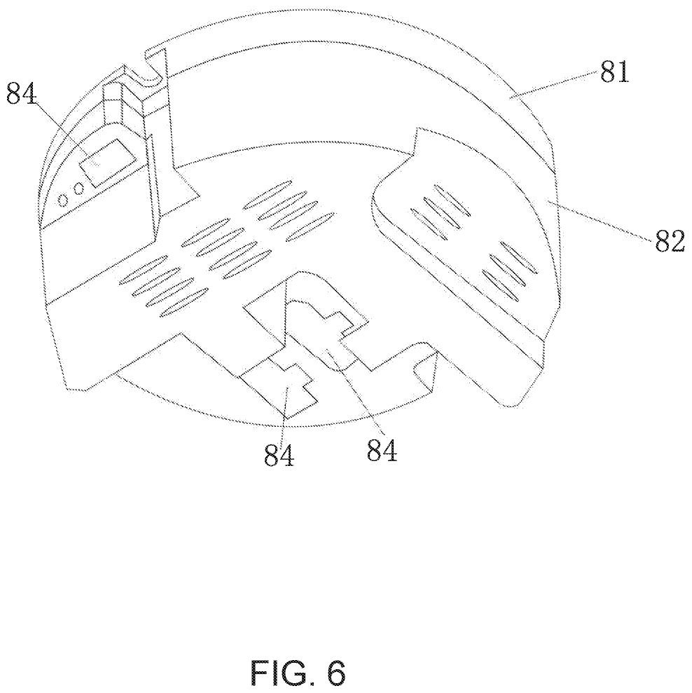

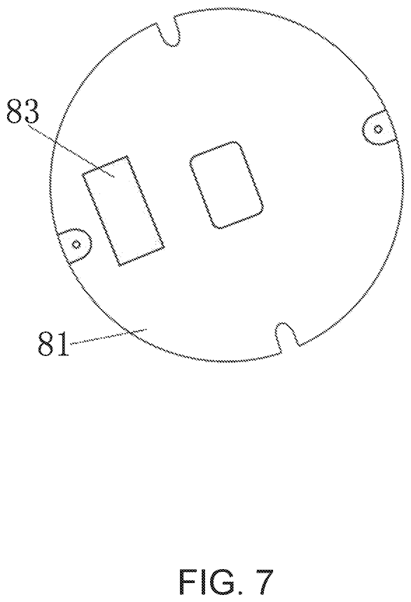

As shown in FIG. 4 to FIG. 7, based on the foregoing embodiment, the solution also provides a controller mounting structure of a ceiling fan lamp using a DC brushless motor 1, including a control box 3 disposed below a fan 2 of the ceiling fan lamp using the DC brushless motor 1, and a controller body 6 is provided in the control box 3. The controller body 6 may be electrically connected with the DC brushless motor 1 of the ceiling fan lamp using the DC brushless motor 1, and a lamp of the ceiling fan lamp using the DC brushless motor 1, respectively. The control box 3 may include a metal upper case 31 and a metal lower cover 32 coupled with the metal upper case 31, and the metal upper case 31 may be provided with a fan control switch. The fan control switch may include a first switch 4 for controlling clockwise and anti-clockwise rotation function of the fan 2, and a second switch 5 for controlling starting, rotating speed, gear shifting and stopping of the fan 2. The first switch 4 and the second switch 5 may be independently connected to the controller body 6 through electric wires respectively. A bottom of the metal lower cover 32 may be connected to a lampshade 33 of the lamp of the ceiling fan lamp using the DC brushless motor 1.

The structure may further include a third switch 9 for controlling the lamp. The third switch 9 may be a rope-pulling switch provided on the metal upper case 31 and connected to the controller body 6 through an electric wire, or a remote control switch fixed to a wall body and connected to the controller body 6 through an electric circuit. In the present embodiment, the third switch 9 is a rope-pulling switch provided on the metal upper case 31 and connected to the controller body 6 through an electric wire.

Specifically, the first switch 4 is a push-setting switch, and the second switch 5 and the third switch 9 are both rope-pulling switches. The controller body 6 has two electric wires connected to the first switch 4. The switching of the directions of rotation of the DC brushless motor 1 can be controlled by pushing the open and close of the first switch 4 so as to control the directions of rotation of the ceiling fan 2. The controller body 6 has two electric wires connected to the second switch 5. The starting, changing of speed and stopping of the DC brushless motor 1 can be controlled by pulling the second switch 5 so as to control the running and shifting of gear of the ceiling fan 2. A wiring of the controller body 6 leading to the lamp may be connected to the third switch 9. The lamp can be switched on and off through the third switch 9. The input power line of the ceiling fan lamp may be connected to the controller body 6 through a terminal. The three-phase wiring of the DC brushless motor 1 may be connected to the controller through the terminal. The pulling ropes of the first switch 4 and the second switch 5 may be of different colours. This can facilitate a user to distinguish which one is for shifting gear and which one is for switching on and off the lamp.

The controller body 6 may include a case body, a heat sink, and a circuit board located in the case body. The case body may be formed by an upper plastic outer shell 81 and a lower plastic outer shell 82. A heat sink fixing trough 83 may be provided on top of the upper plastic outer shell 81. The heat sink may be connected to a discrete component on the circuit board. The circuit board may be pre-set with several wiring sockets, and the lower plastic outer shell 82 may be provided with several socket slot holes 84 that correspond to the wiring sockets.

An upper surface of the heat sink may be in contact with the metal upper case 31 of the control box 3. The heat sink can dissipate the heat from the discrete component through the metal upper case 31. In the present embodiment, the heat sink is an aluminum sheet.

An upper surface of the metal upper case 31 may be provided with several screw holes for fixing the controller body 6, and a fixing hole for fixing a ground wire.

A side surface of the metal upper case 31 may be provided with an engaging slot for fixing the first switch 4. The side surface of the metal upper case 31 may be integrally formed with two independent and separate protruding portions through which the pulling ropes of the second switch 5 and the third switch 9 can extend.

The metal upper case 31 and the metal lower cover 32 can be connected by snap-fitting or fixedly connected by screws.

Several slot holes 43 may be evenly distributed at a lower portion of the metal upper case 31, and several elastic snapping posts 44 that can be snap-fitted into the slot holes 43 may be evenly distributed at an upper portion of the metal lower cover 32. The metal lower cover 32 and the metal upper case 31 can be easily snap-fitted together by pressing the elastic snapping posts 44. This is convenient for disassembly and maintenance.

The metal lower cover 32 may be arc-shaped. Several support columns may be provided in the metal lower cover 32. The support columns can support the controller body 6 so that there is a certain distance between the controller body 6 and the metal lower cover 32, and sufficient heat dissipation space for the controller body 6 is provided. This can extend the life of the controller body.

The above are only preferred embodiments of the present disclosure and are not intended to limit the present disclosure. Any slight modifications, equivalents and modifications of the above embodiments made according to the technical substance of the present disclosure are all included within the scope of protection of the technical solution of the present disclosure.

What is claimed is:

1. A controller mounting structure of a ceiling fan using a DC brushless motor, comprising a control box disposed below the DC brushless motor of the ceiling fan; a controller body disposed inside the control box and electrically connected to the DC brushless motor; the control box comprising a metal upper case and a metal lower cover coupled with the metal upper case, wherein the metal upper case is provided with a first switch for controlling clockwise and anti-clockwise rotation function of the fan, and a second switch for controlling rotating speed, gear shifting and stopping functions of the fan, the first switch and the second switch are independently connected to the controller body through electric wires respectively, the controller body comprising a case body, a heat sink, and a circuit board located in the case body, wherein the case body is formed by an upper plastic outer shell and a lower plastic outer shell, a heat sink fixing trough is provided on top of the upper plastic outer shell, the heat sink is connected to a discrete component on the circuit board and an upper surface of heat sink is in contact with the metal upper case, the circuit board is pre-set with several wiring sockets, and the lower plastic outer shell is provided with several socket slot holes that correspond to the wiring sockets, and several heat-dissipating holes.

2. The controller mounting structure of a ceiling fan using a DC brushless motor according to claim 1, wherein the heat sink comprises an aluminum sheet.

3. The controller mounting structure of a ceiling fan using a DC brushless motor according to claim 1, wherein the heat sink is a metal heat sink with a surface coated with a layer of graphene, or a graphene plate.

4. The controller mounting structure of a ceiling fan using a DC brushless motor according to claim 1, wherein an upper surface of the metal upper case is provided with an upwardly protruding raised platform, the upper surface of the metal upper case is provided with several screw holes for fixing the controller body, the raised platform is provided with a fixing hole for fixing a ground wire and a through hole for facilitating electrical connection between the DC brushless motor and the controller body, a side surface of the metal upper case is provided with two independent and separate hole locations for fixing the first switch and the second switch respectively, and positioning holes corresponding to the screw holes are provided around the upper plastic outer shell.

5. The controller mounting structure of a ceiling fan using a DC brushless motor according to claim 1, wherein a heat-dissipating hole is provided on a side surface of the lower plastic outer shell.

6. The controller mounting structure of a ceiling fan using a DC brushless motor according to claim 1, wherein the first switch is a push-setting switch or a rope-pulling switch, and the second switch is a push-setting switch or a rope-pulling switch.

7. The controller mounting structure of a ceiling fan using a DC brushless motor according to claim 6, wherein the first switch and the second switch are both rope-pulling switches, and pulling ropes of the first switch and the second switch are of different colours.

8. The controller mounting structure of a ceiling fan using a DC brushless motor according to claim 1, wherein the metal upper case and the metal lower cover are connected by snap-fitting, or fixedly connected by screws.

9. A controller mounting structure of a ceiling fan lamp using a DC brushless motor, comprising a control box disposed below a fan of the ceiling fan lamp using the DC brushless motor; a controller body is provided in the control box, the controller body being electrically connected with the DC brushless motor of the ceiling fan lamp using the DC brushless motor and a lamp of the ceiling fan lamp using the DC brushless motor, respectively, the control box comprising a metal upper case and a metal lower cover coupled with the metal upper case, wherein the metal upper case is provided with a fan control switch, the fan control switch is connected with the controller body through an electric wire, and a bottom of the metal lower cover is connected to a lampshade of the lamp of the ceiling fan lamp using the DC brushless motor.

10. The controller mounting structure of a ceiling fan lamp using a DC brushless motor according to claim 9, wherein the fan control switch comprises a first switch for controlling clockwise and anti-clockwise rotation function of the fan, and a second switch for controlling starting, rotating speed, gear shifting and stopping of the fan, the first switch and the second switch being independently connected to the controller body through electric wires respectively.

11. The controller mounting structure of a ceiling fan lamp using a DC brushless motor according to claim 10, wherein the first switch is a push-setting switch or a rope-pulling switch, and the second switch is a rope-pulling switch.

12. The controller mounting structure of a ceiling fan lamp using a DC brushless motor according to claim 9, further comprising a third switch for controlling the lamp, the third switch is a rope-pulling switch provided on the metal upper case and connected to the controller body through an electric wire, or a remote control switch fixed to a wall body and connected to the controller body through an electric circuit.

13. The controller mounting structure of a ceiling fan lamp using a DC brushless motor according to claim 9, wherein the controller body comprises a case body, a heat sink, and a circuit board located in the case body, wherein the case body is formed by an upper plastic outer shell and a lower plastic outer shell, a heat sink fixing trough is provided on top of the upper plastic outer shell, the heat sink is connected to a discrete component on the circuit board, the circuit board is pre-set with several wiring sockets, and the lower plastic outer shell is provided with several socket slot holes that correspond to the wiring sockets.

14. The controller mounting structure of a ceiling fan lamp using a DC brushless motor according to claim 10, wherein an upper surface of the heat sink is in contact with the metal upper case of the control box.
